(19) United States
(12) Patent Application Publication
(10) Pub. No.: US 2007/0016471 A1
(43) Pub. Date: Jan. 18, 2007

(54) SYSTEMS AND METHODS FOR ADVERTISING USING ONE OR MORE RAIL CARS

(75) Inventor: Dave Fellon, St. Paul, MN (US)

Correspondence Address: CROMPTON, SEAGER & TUFTE, LLC, 1221 NICOLLET AVENUE, SUITE 800, MINNEAPOLIS, MN, 55403-2420, US

(73) Assignee: PROGRESSIVE RAIL, Lakeville, MN (US)

(21) Appl. No.: 11/160,847

(22) Filed: Jul. 12, 2005

(51) Int. Cl. G06Q 30/00

(52) U.S. Cl. 705/14

(57) ABSTRACT

Systems and methods for using rolling rail stock, such as one or more rail cars, as an advertising platform are provided. In one illustrative embodiment, a fee is accepted for providing an advertisement on one or more freight cars, and for releasing the freight cars onto a rail road network. Once released, the location of the freight cars may be tracked and recorded at one or more points in time, and stored as location data. An advertiser or other entity may be provided with at least some of the location data to show the real time and/or historical movement of the freight car along the rail road network. In some embodiments, an agreement is formed between two or more rail road entities, the agreement including an obligation for each rail road entity to perform quality checks and/or maintenance on advertisements positioned on those rail cars that are owned or leased by the other rail road entities that are part of the agreement when the rail cars enter or are in the rail yard of the receiving rail road entity. Each of the rail road entities that are part of the agreement may then accept a fee for placement of advertisements on one or more of its rail cars, and each rail road entity may release onto the rail road network one or more of its rail cars that have a placed advertisement.

### TECHNICAL FIELD

The present invention generally relates to systems and methods for advertising, and more particularly, to systems and methods for using rolling rail stock, such as one or more rail cars, as an advertising platform in high visibility locations.

### BACKGROUND

There are a wide variety of advertising outlets available to advertisers. Some of these include television, radio, magazines, newspapers, billboards, trucks, as well as others. One under utilized advertising platform is the fleet of rolling rail stock, such as rail road cars. While some rail road cars may include a name of a company that owns the rail car, there does not appear to be any systematic approach to allow advertisers in general to use and exploit the rather large advertising space provided by the fleet of rail cars. From the foregoing, it can be appreciated that there is a need for improved systems and methods for providing advertisers with access to rolling rail stock as an advertising platform.

### SUMMARY

The present invention provides systems and methods for using rolling rail stock, such as one or more rail cars, as an advertising platform. In one illustrative embodiment, a fee is accepted for providing an advertisement on one or more freight cars, and for releasing the freight cars onto a rail road network. Once released, the location of the freight cars may be tracked and recorded at one or more points in time, and stored as location data. The location of the freight cars may be tracked and recorded using, for example, scanners positioned at predetermined locations along the rail road network such as the existing system of Automatic Equipment Identification (AEI) scanners. Alternatively, or in addition, the location of the freight cars may be provided by Global Positioning Systems affixed to the freight cars, or by any other suitable method.

An advertiser or other entity may be provided with at least some of the location data to show the real time and/or historical movement of the freight car along the rail road network. In some cases, the fee charged to the advertiser may depend on the path that is actually taken by the rail car, but this is not required.

In some cases, the freight cars may be released onto the rail road network with a free runner status. A free runner is a rail car that can be sent anywhere on the rail network, and no effort is made to keep the rail car on the owner's own rail lines or returned the owner's origin or site. The owner of the rail car is typically compensated on a per mile basis by the shippers that use the rail car. In many cases, free runners move about the rail network in an unpredictable manner, often traveling to many parts of the rail network over time. Alternatively, the freight cars may be assigned to a particular route, such as between two or more locations; one example of which is between a mine and a port. In yet other cases, the freight cars may be assigned for use almost exclusively on the owner's own rail network.

In some illustrative embodiments, an agreement is formed between two or more rail road entities, each having at least one rail yard connected to a common rail road network. The agreement may be formed between, for example, short rail lines, regional rail lines, national rail lines, or any combination thereof. The agreement may include, for example, an obligation for each rail road entity to perform quality checks on advertisements positioned on those rail cars that are owned or leased by the other rail road entities that are part of the agreement when the rail cars enter or are in the rail yard of the receiving rail road entity. The agreement may also include an obligation for each rail road entity to perform maintenance on advertisements positioned on those rail cars that are owned or leased by the other rail road entities that are part of the agreement when the rail cars enter or are in the rail yard of the receiving rail road entity. Maintenance may include, for example, removing graffiti from the advertisements, replacing damaged advertisements, as well as other maintenance tasks.

Each of the rail road entities that are part of the agreement may accept a fee for placement of advertisements on one or more of its rail cars, and each rail road entity may release one or more of its rail cars that have a placed advertisement onto the rail road network. Once released, the location of at least selected rail cars on the rail road network may be recorded at one or more points in time and stored as location data. At least some of the location data may be provided to at least one designated person or entity, such as one or more of the participating rail road entities, a client advertiser, or any other designated person or entity as desired.

The above summary of the present invention is not intended to describe each disclosed embodiment or every implementation of the present invention. The figures, description and examples which follow more particularly exemplify these embodiments.

### BRIEF DESCRIPTION OF THE FIGURES

The invention may be more completely understood in consideration of the following detailed description of various embodiments of the invention in connection with the accompanying drawings, in which:

FIG. 1 is a side view of an illustrative embodiment of the present invention, which includes a number of rail cars with advertisement affixed to at least one side parked in a high visibility location;

FIG. 2 is a top view of another illustrative embodiment of the present invention, which includes a number of rail cars with advertisement affixed to at least one side parked in a high visibility location;

FIG. 3 is a top view of yet another illustrative embodiment of the present invention, which includes a number of rail cars with advertisement affixed to at least one side parked in a high visibility location;

FIG. 4 is a flow diagram of an illustrative method for generating advertising revenue through the use of one or more rail cars;

FIG. 5 is a flow diagram of another illustrative method for generating advertising revenue through the use of one or more rail cars;

FIG. 6 is a schematic view of an illustrative rail road network;

FIG. 7 is a print out showing location data for a number of rail cars on a rail road network;

FIG. 8 is a flow diagram of an illustrative method for generating advertising revenue through the use of one or more rail cars on a rail road network;

FIG. 9 is a flow diagram of another illustrative method for generating advertising revenue through the use of one or more rail cars on a rail road network;

FIG. 10 is a flow diagram of another illustrative method for generating advertising revenue through the use of one or more rail cars on a rail road network;

FIG. 11 is a flow diagram of another illustrative method for generating advertising revenue through the use of one or more rail cars on a rail road network;

FIG. 12 is a flow diagram of another illustrative step that can be used in conjunction with the method of FIG. 11;

FIG. 13 is a flow diagram of additional illustrative steps that can be used in conjunction with the method of FIG. 11;

FIG. 14 is a flow diagram of an illustrative method for generating advertising revenue through the use of one or more rail cars on a rail road network;

FIG. 15 is a perspective view of an illustrative rail car that has been adapted to appear like an oversized product;

FIG. 16 is a side view of another illustrative rail car that has been adapted to appear like an oversized product;

FIG. 17 is a side view of an illustrative rail car that supports a product model;

FIG. 18 is a side view of another illustrative rail car that supports a product or product model; and

FIG. 19 is a flow diagram of an illustrative method for generating advertising revenue through the use of one or more rail cars.

While the invention is amenable to various modifications and alternative forms, specifics thereof have been shown by way of example in the figures and will be described in detail. It should be understood, however, that the intention is not to limit the invention to the particular embodiments described. On the contrary, the intention is to cover all modifications, equivalents, and alternatives falling within the spirit and scope of the invention.

### DESCRIPTION

The following description should be read with reference to the drawings, in which like elements in different drawings are numbered in like fashion. The drawings, which are not necessarily to scale, depict selected embodiments and are not intended to limit the scope of the invention. Although examples of construction, dimensions, and materials are illustrated for the various elements, those skilled in the art will recognize that many of the examples provided have suitable alternatives that may be utilized.

The present invention provides systems and methods for using rolling rail stock, such as one or more rail cars, as an advertising platform. In a first illustrative embodiment, one or more advertisements may be affixed to at least one side of a rail car, and the rail car may be parked on a track in a high visibility location. In some cases, the advertisement(s) promote a good or service of an entity other than the owner(s) of the rail car.

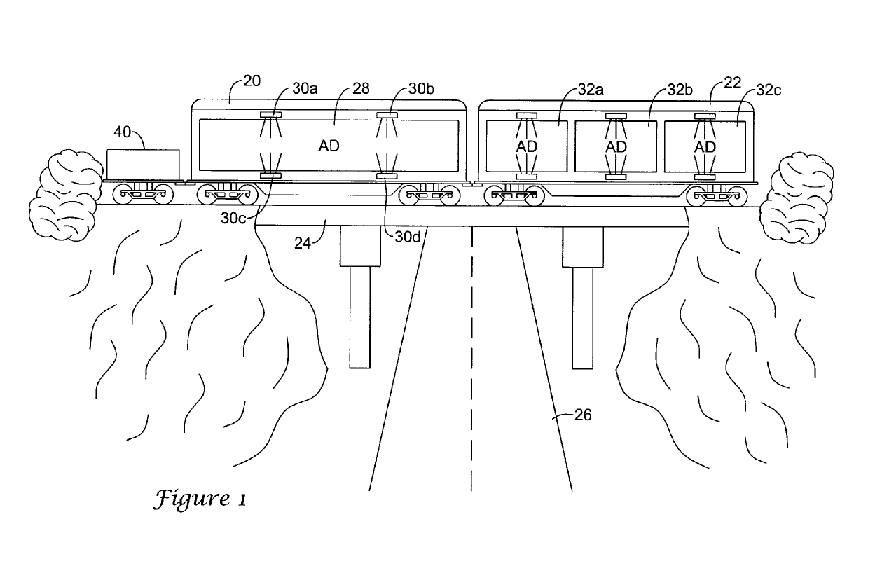

FIG. 1 shows one such illustrative embodiment. In FIG. 1, a first rail car 20 and a second rail car 22 are parked on track that extends over a bridge 24. The bridge 24 extends over a roadway 26. The first rail car 20 includes an advertisement 28 affixed to at least one side of the rail car 20. The second rail car 22 is shown having multiple advertisements 32a, 32b and 32c affixed to a side of rail car 22. The roadway 26 may be chosen to be a fairly busy roadway, and thus the bridge 24 may provide a high visibility location for advertisements 28 and 32a-32c.

It is contemplated that the advertisement 28 may be affixed to the first and second rail cars 20 and 22 in any suitable manner. For example, the advertisement 28 may be painted on the side of the first rail car 20. Alternatively, the advertisement 28 may be provided on a film or other suitable substrate that is then secured to the side of the rail car 20 via an adhesive or the like. In yet other embodiments, the advertisement 28 may be provided on a separate rigid substrate that is then affixed to a side of the rail car 20 by clips, screws, brackets or other attachment mechanism. In some cases, the advertisement 28 may be configured to be retractable (e.g. like a window shade) and/or movable (e.g. a loop with more than one advertisement provided thereon, which can then be rotated to allow each advertisement to be scrolled and then displayed for a period of time), as desired. Advertisements 32a-32c may be affixed to the second rail car 22 in a similar manner.

In some cases, the advertisements, such as advertisement 28, may be illuminated by one or more lights 30a-30d. In the illustrative embodiment, the lights 30a-30d are mounted to the first rail car 20, but it is contemplated that lights 30a-30d may be provided on the ground adjacent to the rail car 20, if desired. In some cases, the lights 30a-30d may be powered by a generator or the like that is stored in the first rail car 20. Similar lights may be provided to illuminate advertisements 32a-32c.

The rail cars 20 and 22 may be any suitable type of rail car. For example, the rail cars 20 and 22 may be freight cars such as box cars, tanker cars, hopper cars, gondola cars, automobile hauler cars, or any other type of freight rail car, as desired. In some cases, the rail cars 20 and 22 may be flat bed rail cars that are adapted to include a vertically extending surface, similar to a bill board.

While only two rail cars 20 and 22 are shown in FIG. 1, it is contemplated that only one rail car, or more than two rail cars, may be provided if desired. In many embodiments, all of the rail cars will have at least one advertisement affixed to at least one side. However, in other embodiments, only some of the rail cars will have advertisements. Preferably, at least thirty percent (30%) of the rail cars that are parked in the high visibility location have at least one advertisement affixed to at least one side. In some cases, at least fifty percent (50%), and more preferably at least eighty percent (80%) of the rail cars that are parked in the high visibility location have at least one advertisement affixed to at least one side. In some cases, one hundred percent (100%) of the rail cars that are parked in the high visibility location have at least one advertisement affixed to at least one side, but this is not required in all embodiments.

In some embodiments, the rail cars 20 and 22 may be parked continuously or substantially continuously in the high visibility location for an extended period of time, such as greater than a day, greater than a week, greater than a month, greater than two months, or longer. In some cases, a monthly (or other agreed upon period) fee may be charged to allow the rail cars 20 and 22 to be parked on the track in the high visibility location. Using the rail cars 20 and 22 in this fashion is contrary to the normal use of a rail car, which in many cases, is to maximize the use of the rail car for the transportation of goods.

In some cases, rolling rail stock such as one or more rail cars may be moved along the track when in or around the high visibility location. For example, and in one illustrative embodiment, a mover 40 may be provided that moves the rail cars 20 and 22 along a finite length of the rail road track so that at least selected rail cars 20 and 22 pass by the high visibility location over time. This may be particularly advantageous when all of the rail cars cannot be simultaneously viewed from the high visibility location. For example, and referring to FIG. 1, if four more rail cars were provided to the right of rail car 22, some of these rail cars may not be viewable by motorists traveling along the roadway 26. The mover 40 may move the rail cars over time, so that all or most of the rail cars can be exposed to the high visibility location for at least a period of time.

In some cases, the mover 40 may move the rail cars back and forth along a finite length of rail road track so that at least selected rail cars repeatedly pass the high visibility location over a period of time. It is contemplated that the mover 40 may move the rail cars incrementally, with a delay between each incremental move, or continuously, as desired, and the mover 40 may be manned or un-manned, depending on the application.

In some cases, the mover 40 may move the rail cars so that particular rail cars are exposed to the high visibility location at certain times of a day or week, and other rail cars are exposed at other times of the day or week. For example, the mover 40 may move the rail cars such that a first set of rail cars are exposed to the high visibility location during the morning commute, a second set of rail cars are exposed during lunch time, and yet a third set of rail cars are exposed during the evening commute. Alternatively, or in addition, the mover 40 may move the rail cars such that a first set of rail cars are exposed to the high visibility location during the work week, and a second set of rail cars are exposed during the week end. These are just a few examples of how the mover 40 can change which rail car advertisements are displayed over time.

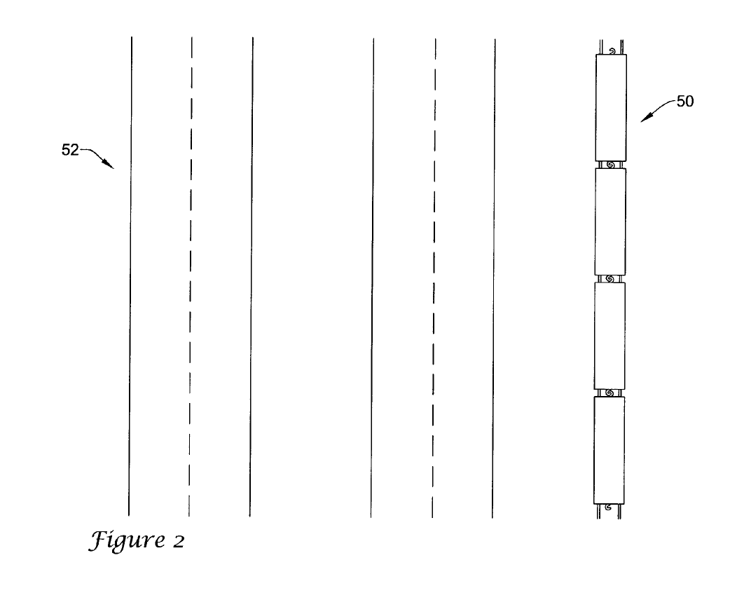

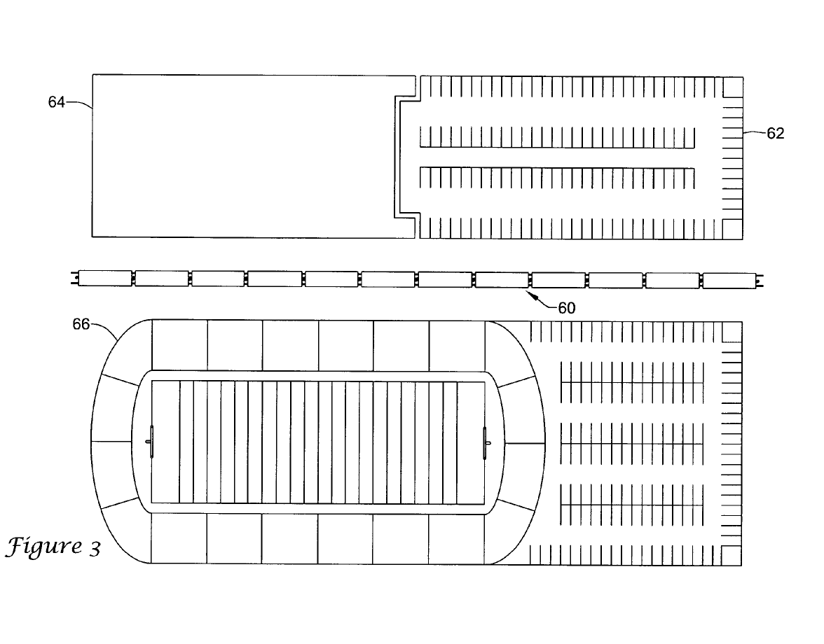

FIG. 2 is a top view of another illustrative embodiment of the present invention. This illustrative embodiment includes a number of rail cars 50, some or all of which have an advertisement affixed to at least one side, which are parked adjacent and extend substantially parallel to a road way 52. The rail cars 50 are preferably moved and then parked outside of a conventional rail yard. FIG. 3 is a top view of yet another illustrative embodiment of the present invention, which includes a number of rail cars 60, some or all of which have an advertisement affixed to at least one side, which are parked adjacent to a parking lot 62, a shopping center 64 and/or a sporting event 66. The rail cars 60 shown in FIG. 3 are also preferably moved and then parked outside of a conventional rail yard.

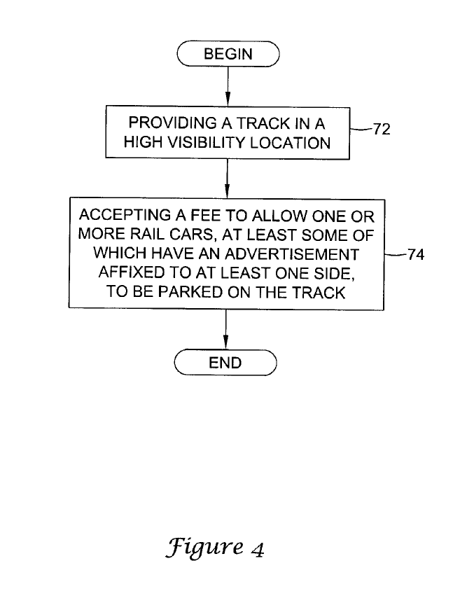

FIG. 4 is a flow diagram of an illustrative method for generating advertising revenue through the use of one or more rail cars. In the illustrative method, a track in a high visibility location is provided, as shown at 72. A fee is then negotiated and accepted to allow one or more rail cars, at least some of which have an advertisement affixed to at least one side, to be parked on the track, sometimes for an extended period of time.

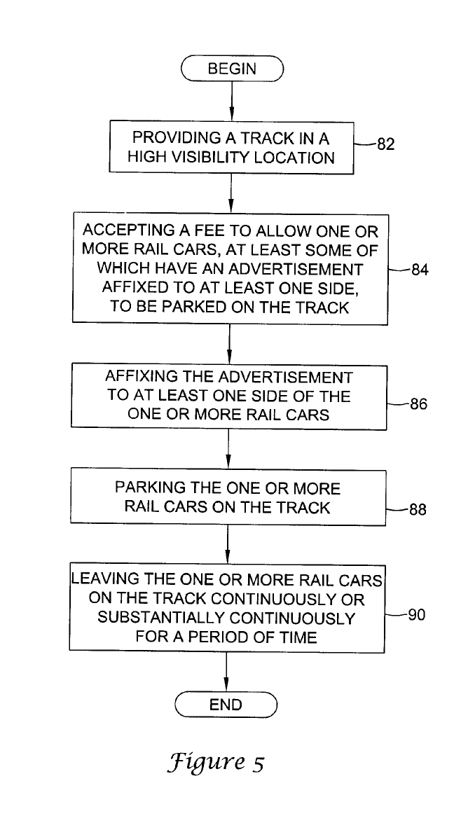

FIG. 5 is a flow diagram of another illustrative method for generating advertising revenue through the use of one or more rail cars. In this illustrative method, a track in a high visibility location is provided, as shown at 82. A fee is then negotiated and accepted, as shown at 84, for: (1) affixing an advertisement to one or more rail cars, as shown at 86; parking the one or more rail cars on the track, as shown at 88; and leaving the one or more rail cars on the track continuously or substantially continuously for a period of time, as shown at 90, sometimes for an extended period of time.

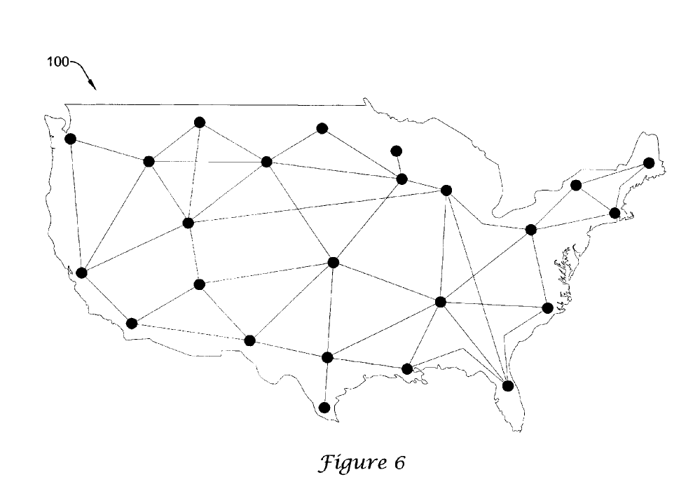

FIG. 6 is a schematic view of an illustrative rail road network. The illustrative rail road network shown in FIG. 6 is not intended to accurately represent the actual rail road network in the United States, but rather is only schematically shown for discussion purposes. Also, it is recognized that other countries have similar rail road networks, and that the present invention is equally applicable to those rail networks as well.

The illustrative rail road network is generally shown at 100 and includes a number of routes that pass between hubs. Thus hubs are shown as black dots, and the routes are shown as lines extending between the black dots. The hubs may correspond to rail yards, and are often located in or near cities. During use, goods are typically loaded onto rail cars at one of the hubs, and the rail cars are sorted by destination hub and hooked together to form trains. The trains are then driven to a destination hub, and the rail cars for that destination hub are unhooked and ultimately unloaded. In some cases, rail cars are hooked to a train and delivered to an intermediate location, and then hooked to one or more other trains before arriving at the desired destination hub.

In many cases, short line and/or regional rail lines provide local and regional service, and national rail lines provide long distance service. For example, and in one scenario, a short line rail road may pick up/load rail cars from local businesses, and deliver the loaded rail cars to a rail yard of a regional or national rail line. The regional or national rail line may then pick up and deliver the rail cars to a rail yard in a destination city. A short line rail road that services the destination city may then pick up the rail cars and deliver the rail cars to local businesses. This is just one scenario that often occurs on a rail road network 100, but is should be recognized that many other scenarios also are commonly used and practiced.

To help keep track of the rail cars on the rail road network 100, the location of each rail car is often tracked and recorded at one or more points in time using, for example, scanners positioned at predetermined locations along the rail road network 100. The rail road network 100 in the United States is outfitted with a network of Automatic Equipment Identification (AEI) scanners. To support these scanners, many rail cars have a Radio Frequency Identification tag (RFID) attached to each side of the car. The network of scanners, which are positioned at predetermined locations across the rail road network 100, read the RFID tags and report the location, as well as other information related to the rail cars as they pass, to a centralized computer. Companies such as Steel Roads™ of Cary, N.C., provide a subscription service that allows subscribers to obtain the location data of their rail cars at any give time. In some cases, and particularly for high value freight such as produce, the location of the rail cars may be provided by Global Positioning Systems affixed to the rail cars.

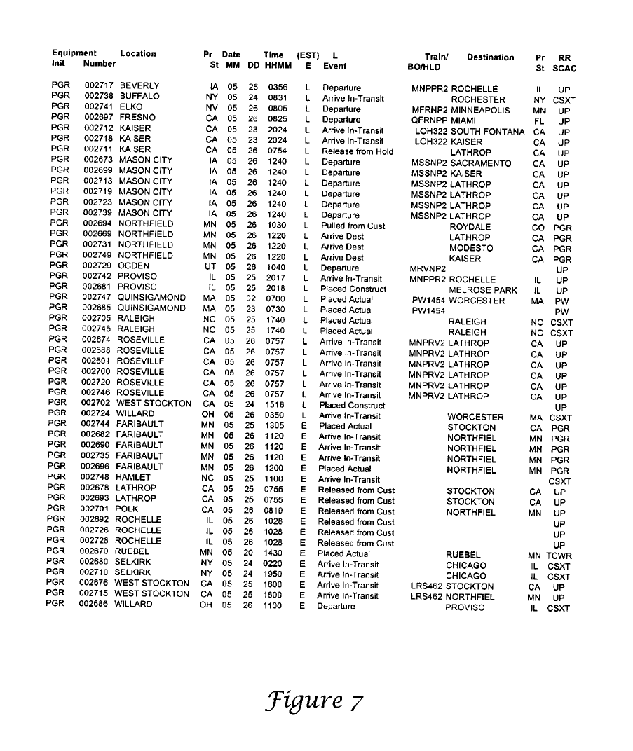

In many cases, rail cars travel widely across the rail road network 100 every year. FIG. 7 is a print out showing location data for a number of rail cars that were released from Lakeville, Minn. as free runners onto the United States rail road network. A free runner is a rail car that can be sent anywhere on the rail network, and no effort is made to keep the rail car on the owner's own rail lines or returned to the owner's origin or site. When the rail car is unloaded at a destination site, the rail car may be assigned and used by anyone for transporting another load. Typically, a shipper may make a request for a particular type of rail car, and if a free runner rail car having the desired characteristics is available, it is assigned to the shipper for use. The owner of the free runner rail car is typically compensated on a per mile basis by the shipper. In many cases, free runners move about the rail network in an unpredictable manner, often traveling to many parts of the rail network over time (e.g. on a national scale), as can be seen from the data shown in FIG. 7.

Some rail cars may be assigned to a particular route, such as between two or more locations. One example of this might be a rail car that is assigned to a route that extends between a coal mine and a sea port. In yet other cases, rail cars may be assigned for use exclusively or almost exclusively on an owner's own rail network. In any event, rail cars can often travel across a wide geographic area over a relatively short time period, often including both rural and urban areas, which may provide desirable exposure for a particular advertising campaign.

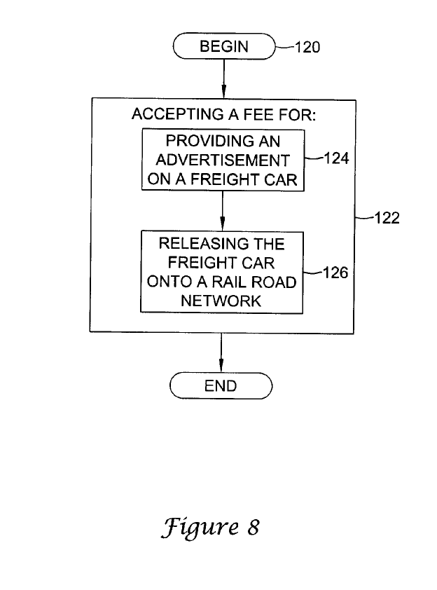

FIG. 8 is a flow diagram of an illustrative method for generating advertising revenue through the use of one or more rail cars on a rail road network. The illustrative method is entered at step 120. A fee is negotiated and accepted for providing an advertisement on one or more freight cars, as shown at 122, and for releasing the freight cars onto a rail road network as shown at 126. In some cases, the fee may be simply for providing a freight car, and for releasing the freight car onto the rail road network. The advertisement may be affixed to the freight car by the advertiser himself or a third party, if desired.

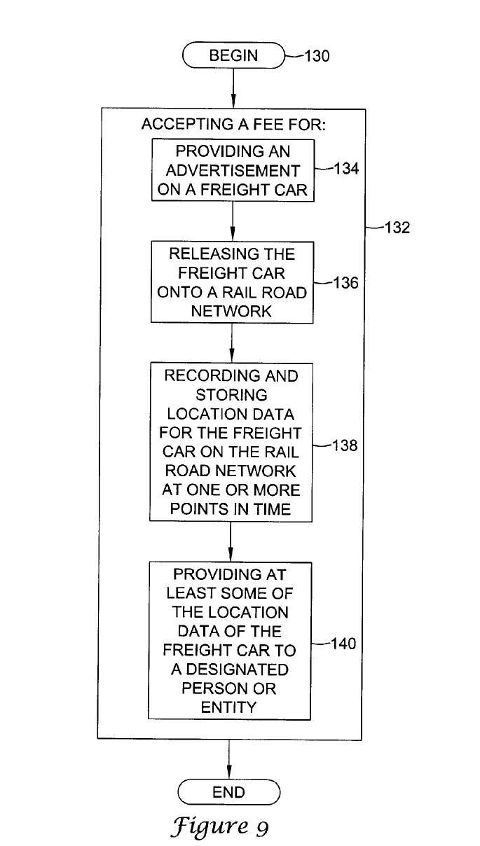

FIG. 9 is a flow diagram of another illustrative method for generating advertising revenue through the use of one or more rail cars on a rail road network. This illustrative method is entered at step 130. A fee is negotiated and accepted for providing advertising on a freight car, as shown at step 132. Once the fee is negotiated and accepted, an advertisement is provided on a freight car as shown at 134, and then released onto a rail road network as shown at 136. Once released, the location of the freight car may be tracked and recorded at one or more points in time and stored as location data, as shown at 138. At least some of the location data may be provided to a designated person or entity, as shown at 140, which in some cases may be the advertiser. The location data may show the real time and/or historical movement of the freight car along the rail road network 100. In some cases, the fee charged to the advertiser may depend on the path that is actually taken by the rail car, but this is not required in all embodiments.

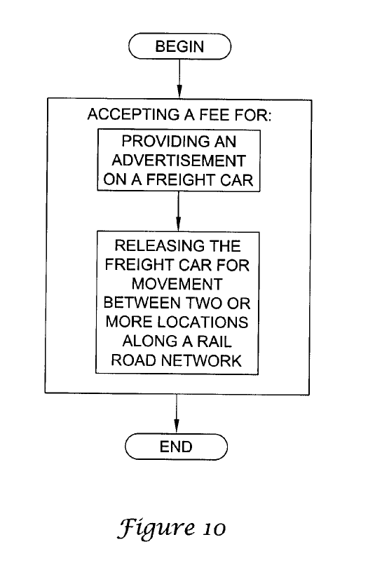

In some cases, the freight car may be released onto the rail road network 100 with a free runner status. As detailed above, a free runner is a rail car that can be sent anywhere on the rail network, and no effort is made to keep the rail car on the owner's own rail lines or returned to the owner's origin or site. Alternatively, and as shown in FIG. 10, the freight car may be assigned to a particular route, such as between two or more locations. One example of this might be between a coal mine and a sea port. In yet other cases, the freight car may be assigned for use exclusively or nearly exclusively on a particular rail roads tracks.

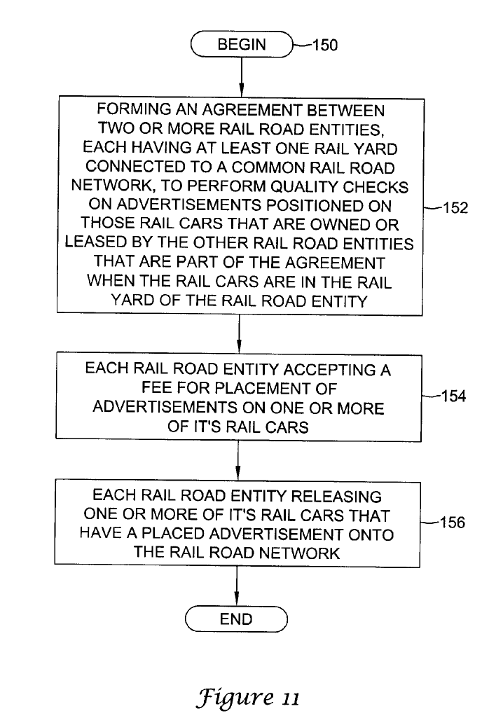

FIG. 11 is a flow diagram of another illustrative method for generating advertising revenue through the use of one or more rail cars on a rail road network. This illustrative method is entered at step 150. At step 152, an agreement is formed between two or more rail road entities, each having at least one rail yard connected to a common rail road network. The agreement may be formed between, for example, short rail lines, regional rail lines, national rail lines, and/or any combination thereof. The agreement may include, for example, an obligation for each rail road entity to perform quality checks on advertisements positioned on those rail cars that are owned or leased by the other rail road entities that are part of the agreement. These quality checks may be performed when the rail cars enter or are in the rail yard of the receiving rail road entity.

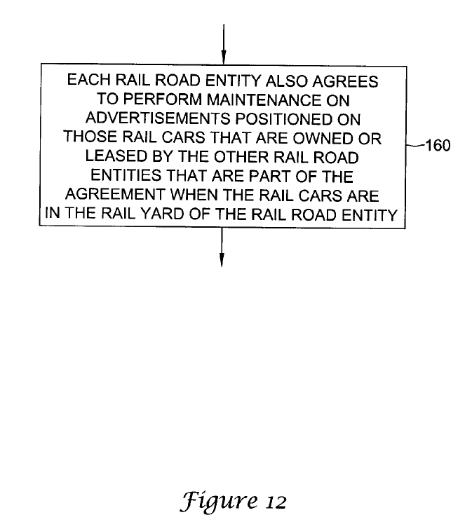

As shown at 160 in FIG. 12, the agreement may also include an obligation for each rail road entity to perform maintenance on advertisements positioned on those rail cars that are owned or leased by the other rail road entities that are part of the agreement. The maintenance on the advertisements may be performed when the rail cars enter or are in the rail yard of the receiving rail road entity. Maintenance may include, for example, removing graffiti from the advertisements, replacing damaged advertisements, as well as other maintenance tasks.

Referring back to FIG. 11, each of the rail road entities that are part of the agreement may accept a fee for placement of advertisements on one or more of its rail cars, as shown at 154, and each rail road entity may release one or more of its rail cars that have a placed advertisement onto the rail road network, as shown at 156.

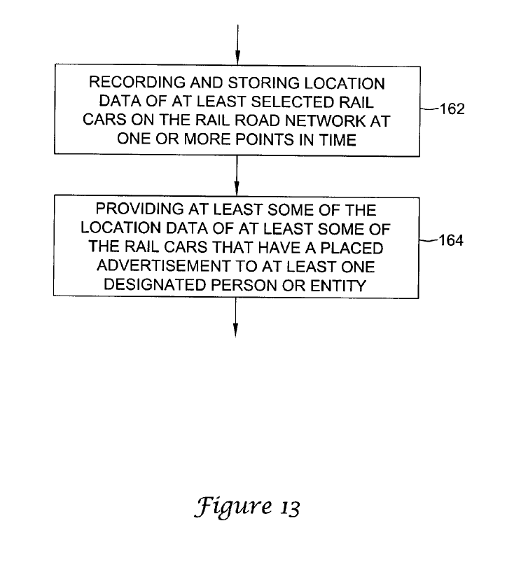

Once the one or more rail cars are released onto the rail road network, and as shown in FIG. 13, the location of at least selected rail cars on the rail road network may be recorded at one or more points in time and stored as location data, as shown at 162. As shown at 164 in FIG. 13, at least some of the location data may then be provided to at least one designated person or entity, such as one or more of the participating rail road entities, a client advertiser, or any other designated person or entity as desired.

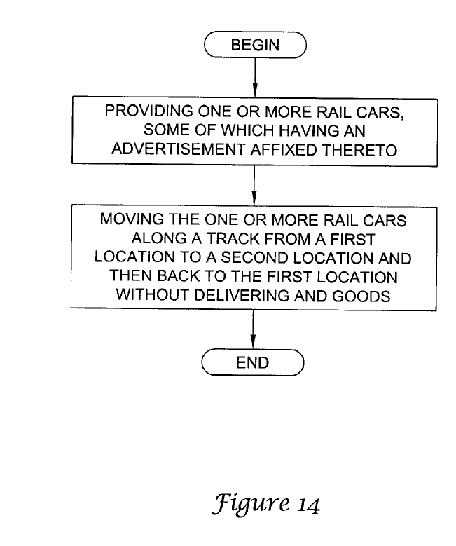

In some cases, it may be desirable to provide targeted advertising along a specific route. For example, it may be desirable to provide advertising along a stretch of road that is hosting a bike race, along a stretch of river that is hosting a boat race, or along a stretch of road that is known to be clogged during certain times of a day or year. These are only some examples. To provide such targeted advertising, and referring to FIG. 14, it may be desirable to provide an advertisement on one or more rail cars that travels adjacent to the target audience. This may be accomplished by, for example, moving a train that includes one or more rail cars with affixed advertisements along a track from a first location to a second location and that passes the target audience, and then back to the first location, without delivering any goods. That is, the rail cars may in some cases be moved along the track for the sole purpose of advertising, and not for the transport of goods. The selected route between the first location and the second location may pass adjacent to the desired targeted audience. A fee may be accepted to provide such advertising and for moving the one or more rail cars between the first and second locations.

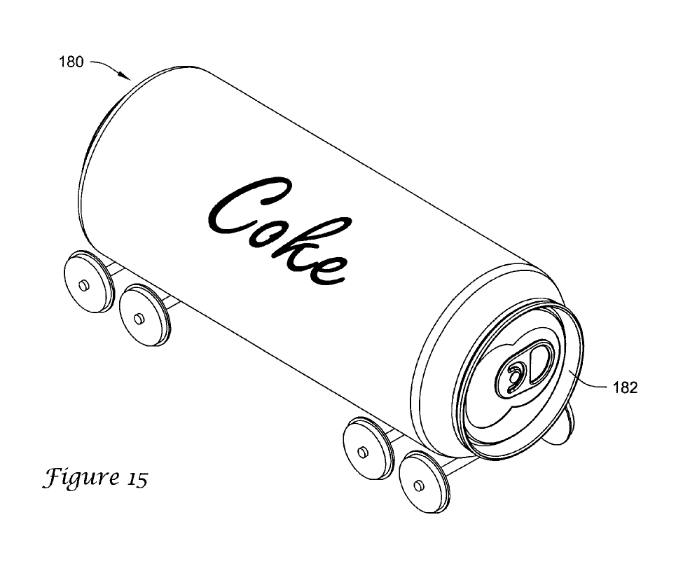

FIG. 15 is a perspective view of an illustrative rail car that has been adapted to appear like a product model of an actual product. In the illustrative embodiment shown in FIG. 15, a tanker rail car 180 has been painted or otherwise adapted to appear as an oversized soda can. In this illustrative embodiment, part of the rail car (e.g. the tank) is used to form at least part of the shape of the product model. Paint, an applied film or other suitable method has been used to transform the tank part of the tanker car to resemble the soda can. A tanker car may be particularly suitable for adoption to resemble cylindrically shaped products, such as bottles, cans, paper towel rolls, toilet paper rolls, Life Saver™ candies, tubes of dough, and/or the like. In some cases, the ends of the tank part of the tanker car may also be adapted to appear like the end of the actual product, such as shown at 182.

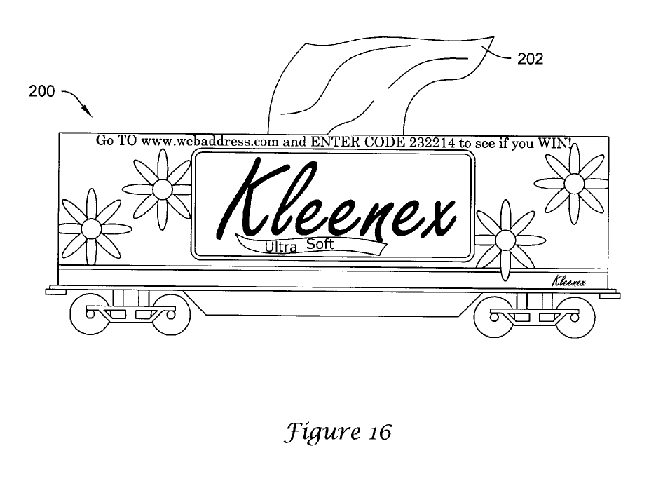

FIG. 16 is a side view of another illustrative rail car that has been adapted to appear like a product model of an oversized product. In this illustrative embodiment, a box car 200 has been painted or otherwise adapted to appear like an oversized tissue box. Like above, part of the rail car (e.g. the box) has been used to form at least part of the shape of the product model. Paint, an applied film or other suitable method has been used to transform the box part of the box car to resemble the tissue box. A box car may be particularly suitable for adoption to resemble rectangular shaped products, such as tissues boxes, juice boxes, cake mixes, cereal boxes, bread loafs, shoe boxes, gum packs, books, office supplies, portable music players, computer and/or computer components, and/or the like. In some cases, the ends of the box of the box car may also be adapted to appear like the end of the actual product.

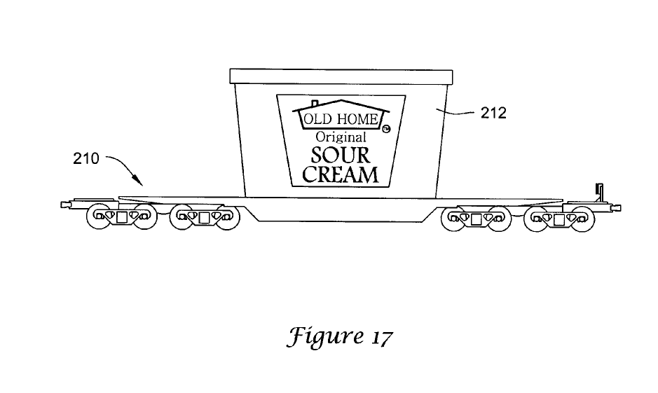

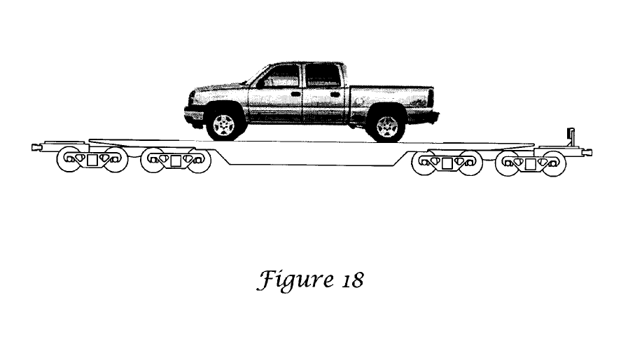

Alternatively, or in addition, a product model may be separately prepared and secured to a rail car. For example, and as shown in FIG. 17, the rail car may be a flat bed rail car 210, and may support a product model of, for example, a sour cream container 212. It is contemplated that the flat bed rail car 210 may support a product model of virtually any types of product including, for example, a car, a boat, or any other product of interest. In some cases, the product model may be the actual product itself, such as an actual car or actual boat, as shown in FIG. 18.

A combination of using part or all of the body of the rail car to form at least part of the shape of the product model, as well as a separately prepared product model forming the rest of the product model, may also be used if desired. For example, and as shown in FIG. 15, the end of the tank car 180 may include a separately prepared product model 182 of the top part of a soda can, and subsequently secured to the end of the tank car 180, but this is not required. In another example, and as shown in FIG. 16, a separately prepared product model 202 of a tissue may be prepared and subsequently secured to the top of the box car 200.

In yet another example, a box car may be adapted to appear as a Nike™ shoe box, and a separately prepared product model of part or all of a shoe may be mounted on the roof of the box car so that it appears from the side that part of a shoe is protruding from the top of the shoe box. In another example, a gondola car may be adapted to appear as a planter, and a separately prepared product model of one or more oversized roses may be mounted on the roof of the gondola car so that it appears from the side that one or more roses are protruding from the top of the planter. A message such as “Our Roses are Bigger” may be provided on the side of the gondola car. Custom built rail cars may also be fabricated to create different effects for different products.

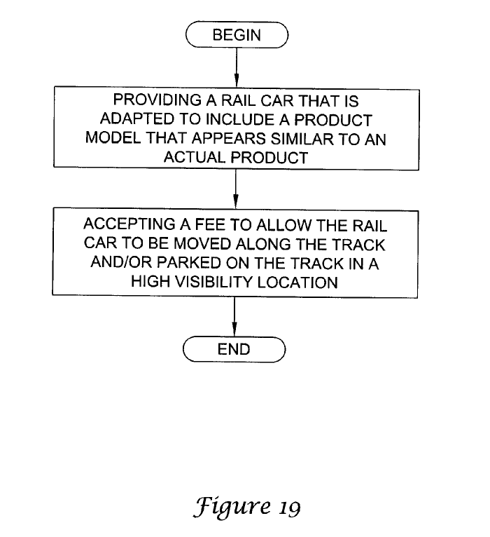

In some illustrative embodiments, a fee may be accepted to adapt a rail car to include a product model, and to allow the adapted rail car to be moved and/or parked on a rail road track. For example, and as shown in FIG. 19, a fee may be accepted for adapting rail car and/or for parking an adapted rail car on a rail road track that is in a high visibility location (e.g. on a bridge that extends over a roadway), or for releasing or moving the adapted rail car about a rail road network, as desired.

In some cases, one or more messages may be provided on a rail car. For example, the one or more message(s) may include an advertising slogan, product information, product promotional information or the like. One illustrative product promotion may include, for example, a message that contains a unique promotional code on rail cars, along with a postal or web address. The illustrative box car shown in FIG. 16 includes the message “Go to www.webaddress.com, and enter Code 232214 to see if you win”. A user seeing the box car in the field is thus prompted to forward the unique promotional code to the address, whereupon a coupon, a prize or any other suitable item or information may be provided to the user. In some cases, the return of the unique promotional code may enter the user in a sweepstakes type drawing. The location at which the user saw the rail car/advertisement may also be provided to the address, if desired, in some cases to help validate the code.

In some embodiments, the location history (see, for example, FIG. 7) of the particular rail car may be provided to the user. The location history of the particular rail car that he/she saw may prove to be of interest to the user, and may help drive and or increase the overall participation in the promotion. For example, a user may find it interested to know what cities the particular rail car he/she saw has traveled over the past month or other time period.

In some cases, the location history of the rail car may be used to determine if the promotional code provided by the user corresponds to a winning promotional code. For example, an advertiser could specify that “Orlando, Fla.” is the city of the month, and any promotional code that is associated with a rail car that passed through Orland, Fla. in the last month is a winning code.

To determine if the promotional code is a winner, the user may be prompted to provide the promotional code to a web site, which in some cases, may display additional advertising and/or promotional information. In some cases, the user would not be notified if the submitted promotional code was a winner until after the specified month passes. This would not only help prevent winning promotional codes from being passed around to others, but also may help increase the number of times that the user must return to the web site, which in many cases, may increase traffic to the web site.

The invention should not be considered limited to the particular examples described above, but rather should be understood to cover all aspects of the invention as set out in the attached claims. Various modifications, equivalent processes, as well as numerous structures to which the invention can be applicable will be readily apparent to those of skill in the art upon review of the instant specification.

What is claimed is:

1. A method for generating revenue, comprising:
accepting a fee for:
providing an advertisement on a freight car; and
releasing the freight car onto a rail road network.

2. The method of claim 1, wherein a location of the freight car on the rail road network is recorded at one or more points in time and stored as location data, the method further comprising providing at least some of the location data of the freight car to a designated person or entity.

3. The method of claim 1, wherein the location of the freight car on the rail road network is recorded at one or more points in time and stored as location data, the method further comprising:
accessing the location data; and
providing at least some of the location data of the freight car to a designated person or entity.

4. The method of claim 2 wherein the location of the freight car on the rail road network is provided by scanners positioned at predetermined locations along the rail road network.

5. The method of claim 4 wherein the scanners are Automatic Equipment Identification (AEI) scanners.

6. The method of claim 2 wherein the location of the freight car on the rail road network is provided by a Global Positioning System affixed to the freight car.

7. A method for generating revenue using a rail road network, comprising:
accepting a fee for:
providing an advertisement on a freight car; and
releasing the freight car for movement between two or more locations along a rail road network.

8. A method for generating revenue, comprising:
forming an agreement between two or more rail road entities, each having at least one rail yard connected to a common rail road network, to perform quality checks on advertisements positioned on those rail cars that are owned or leased by the other rail road entities that are part of the agreement when the rail cars are in the rail yard of the rail road entity;
each rail road entity accepting a fee for placement of advertisements on one or more of it's rail cars; and
each rail road entity releasing one or more of it's rail cars that have a placed advertisement onto the rail road network.

9. The method of claim 8 wherein each rail road entity is a national, regional or short line rail road entity.

10. The method of claim 8 wherein the agreement is a national network of regional and/or short line rail road entities.

11. The method of claim 8 wherein each rail road entity also agrees to perform maintenance on advertisements positioned on those rail cars that are owned or leased by the other rail road entities that are part of the agreement when the rail cars are in the rail yard of the rail road entity.

12. The method of claim 11 wherein the maintenance performed includes removing graffiti, if any, from advertisements positioned on those rail cars that are owned or leased by the other rail road entities that are part of the agreement when the rail cars are in the rail yard of the rail road entity.

13. The method of claim 11 wherein the maintenance performed includes replacement of damaged advertisements positioned on those rail cars that are owned or leased by the other rail road entities that are part of the agreement when the rail cars are in the rail yard of the rail road entity.

14. The method of claim 8, wherein the location of at least selected rail cars on the rail road network is recorded at one or more points in time and stored as location data, the method further comprising:
providing at least some of the location data of at least some of the rail cars that have a placed advertisement to at least one designated person or entity.

15. The method of claim 14, wherein the at least one designated person or entity is a rail road entity that is part of the agreement.

16. The method of claim 14, wherein the at least one designated person or entity is a client advertiser.

17. A method for generating revenue, comprising:
providing a fee to one or more rail road entities to:
place advertisements on one or more of their rail cars; and releasing the rail cars that have a placed advertisement onto a rail road network.

18. The method of claim 17 wherein the one or more rail road entities include regional and/or short line rail road entities.

19. The method of claim 17, wherein the location of at least selected rail cars on the rail road network is recorded at one or more points in time and stored as location data, the method further comprising:
providing at least some of the location data of at least some of the rail cars that have a placed advertisement to at least one designated person or entity.

20. The method of claim 19, wherein the at least one designated person or entity is a client advertiser.

21. The method of claim 17, wherein each rail road entity has a rail yard, and wherein each rail road entity performs quality checks on placed advertisements if/when one or more of the rail cars enters their rail yard from the rail road network.

22. The method of claim 17, wherein each rail road entity has a rail yard, and wherein each rail road entity maintains placed advertisements if/when one or more of the rail cars enters their rail yard from the rail road network.

23. The method of claim 22 wherein the maintenance includes removing graffiti, if any, from the placed advertisements.

24. The method of claim 22 wherein the maintenance includes replacing any damaged placed advertisements.

25. A method for generating revenue comprising:
providing one or more rail cars, some of which having an advertisement affixed thereto; and
moving the one or more rail cars along a track from a first location to a second location and then back to the first location without delivering any goods.

26. The method of claim 25 further comprising accepting a fee to move the one or more rail cars along the track for advertising purposes.

27. The method of claim 25 wherein the track passes a high visibility location between the first location and the second location.
